(19) United States
(12) Patent Application Publication
(10) Pub. No.: US 2002/0112867 A1
(43) Pub. Date: Aug. 22, 2002

(54) Air passage shifting device for a pneumatic tool

(76) Inventor: Ming-Qun Tseng, Miaoli (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/788,395

(22) Filed: Feb. 21, 2001

(51) Int. Cl. B25D 15/00

(52) U.S. Cl. 173/93.5; 173/168

(57) ABSTRACT

An air passage shifting device for a pneumatic tool includes a tube connected to a casing in which a rotator is received. A first passage and a second passage are respectively connected in communication between the casing and the tube. An inlet defined radially through the tube and communicates with a passage in the handle of the tool. A control bar is received in the tube and two recesses are respectively defined in an outer periphery of the control bar. The two recesses movably communicate with the first passage and the second passage when pulling or rotating the control bar to guide air into one of the first passage and the second passage to rotate the rotator.

### FIELD OF THE INVENTION

The present invention relates to an air passage shifting device for a pneumatic tool that includes a bar with two passages and the bar is movable or rotatable to guide air into desired passages to drive the chuck of the tool.

### BACKGROUND OF THE INVENTION

A conventional pneumatic tool generally includes a casing with a rotator received therein which is driven by air introduced from one of two passages to rotate the rotator clockwise or counter clockwise. A chuck is connected to the rotator and secures a tool such as a bit to loosen or tighten an object such as a nut. Nevertheless, the conventional pneumatic tool involves too many parts and these parts make the assembling processes slowly. The locations of the two passages are shifted by way of moving a rack when pulling a trigger and the engagement between the racks and a driving member is so weak that it could be damaged or the rack could be deformed. Some pneumatic tools have two buttons to respectively control the locations of the two air passages and this complicates the molds making the casing of the pneumatic tool.

The present invention intends to provide an air passage shifting device that is easily to be operated and involves micro-adjusting feature to allow desired amount air to enter into the passage.

### SUMMARY OF THE INVENTION

In accordance with one aspect of the present invention, there is provided a pneumatic tool and comprising a barrel portion and a handle in which a passage is connected to an air compressor. A casing having a rotator received therein is securely received in the barrel portion and chuck device is connected to the rotator. A tube is connected to the casing and a first passage and a second passage are respectively connected in communication between the casing and the tube. An inlet is defined radially through the tube and communicates with the passage in the handle. A control bar is received in the tube and two recesses are respectively defined in an outer periphery of the control bar. The two recesses movably communicate with the first passage and the second passage in the tube.

The primary object of the present invention is to provide an air passage shifting device that is easily operated to guide air enter into desired passage to rotate the rotator.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a pneumatic tool of the present invention;

FIG. 2 is a perspective view to show an air passage shifting device connected to a casing of pneumatic tool of the present invention;

FIG. 3 is a cross sectional view to show the position of the control bar when pulling the control bar;

FIG. 4 is a cross sectional view to show the control bar is shifted to let air enter into a first passage;

FIG. 5 is a cross sectional view to show the position of the control bar when the control bar is pushed;

FIG. 6 is a cross sectional view to show the control bar is shifted to let air enter into a second passage;

FIG. 7 is an exploded view to show another embodiment of the air shifting device of the pneumatic tool;

FIG. 8 is a cross sectional view to show the flange of the control bar blocks the second passage;

FIG. 9 is an exploded view to show yet another embodiment of the air shifting device of the pneumatic tool;

FIG. 10 is a cross sectional view to show the control bar shown in FIG. 9 is rotated to let air enter into a first passage, and FIG. 11 is a cross sectional view to show the control bar shown in FIG. 9 is rotated to let air enter into a second passage.

### DETAILED DESCRIPTION OF THE PREFERRED EMBODIMENTS

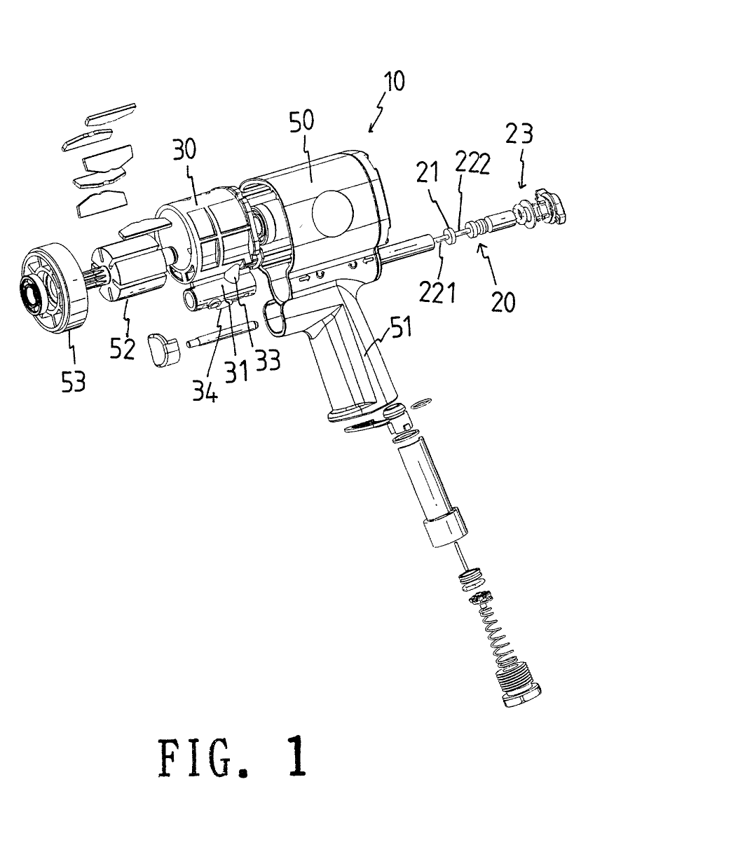

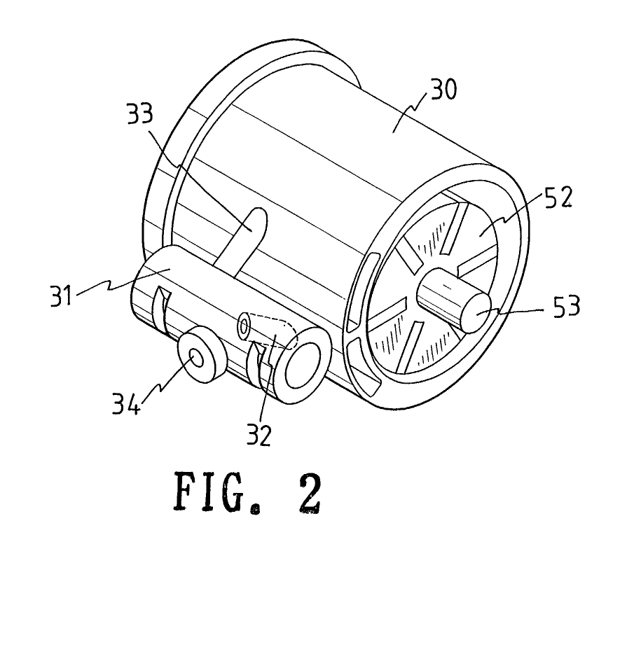

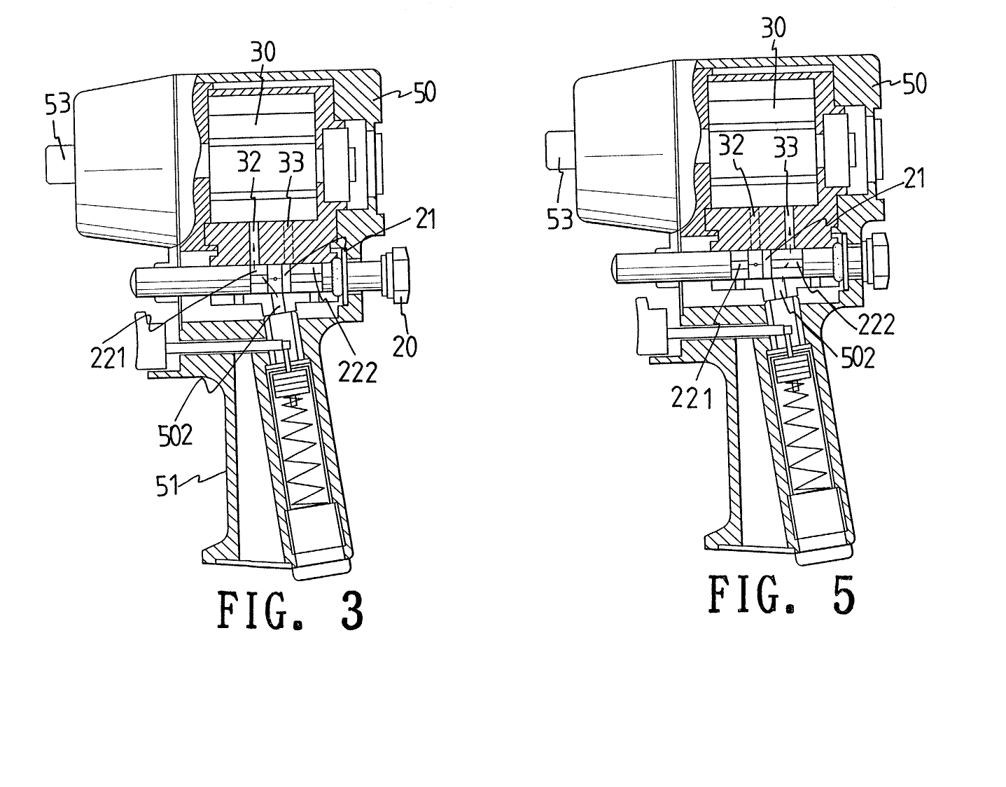

Referring to FIGS. 1 to 4, the pneumatic tool 10 of the present invention comprises a barrel portion 50 and a handle in which a passage 502 is defined and connected to an air compressor (not shown) so that pressurized air is introduced into the barrel portion 50. A casing 30 is securely received in the barrel portion 50 and a rotator 52 is rotatably received in the casing 30. A chuck device 53 is connected to the rotator 52. A tube 31 is connected to the casing 30 and an inlet 34 is defined radially through the tube 31 so as to communicate with the passage 502 in the handle 51. A first passage 32 and a second passage 33 are respectively connected in communication between the casing 30 and the tube 31. A control device 20 includes a control bar 20 which is received in the tube 31 and a positioning device 23 is connected to an end of the control bar 20 to position in a desired position in the tube 31. Two recesses 221, 222 are respectively defined in an outer periphery of the control bar 20 and separated by separation flange 21. The control bar 20 is movable in a longitudinal direction of the tube 31 and positions of the two recesses 221, 222 are moved relative to the tube 31 when pulling or pushing the control bar 20 as shown in FIGS. 3 and 5.

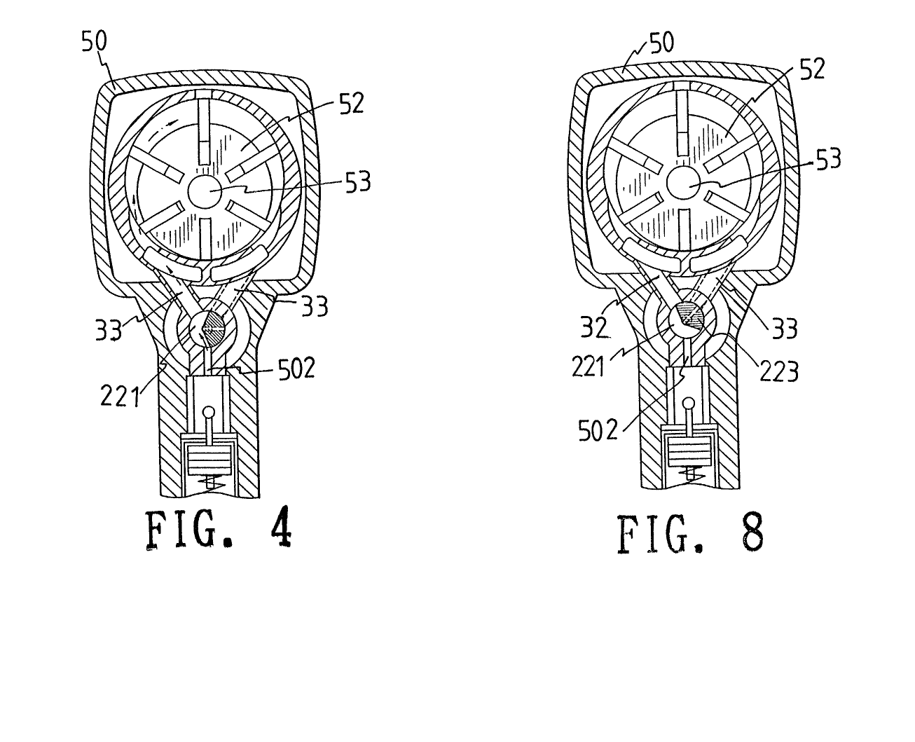

FIGS. 3 and 4 show that when the control bar 20 is pulled, the recesses 221 is shifted and communicates with the first passage 32. The pressurized air enters the casing 30 and rotates the rotator 52 clockwise. FIGS. 5 and 6 show that when the control bar 20 is pushed, the recesses 222 is shifted and communicates with the second passage 33. The pressurized air enters the casing 30 and rotates the rotator 52 counter clockwise.

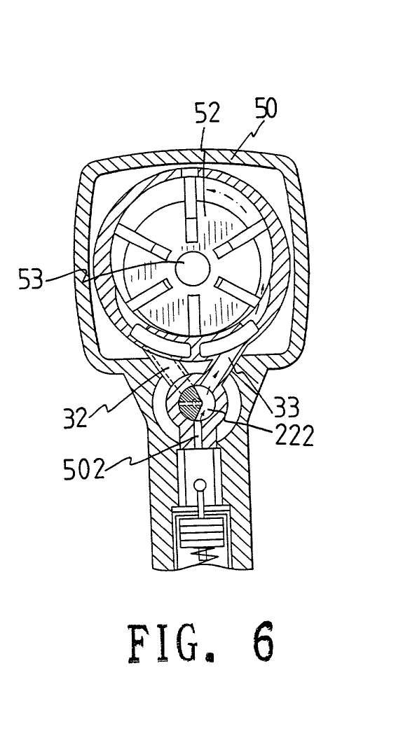

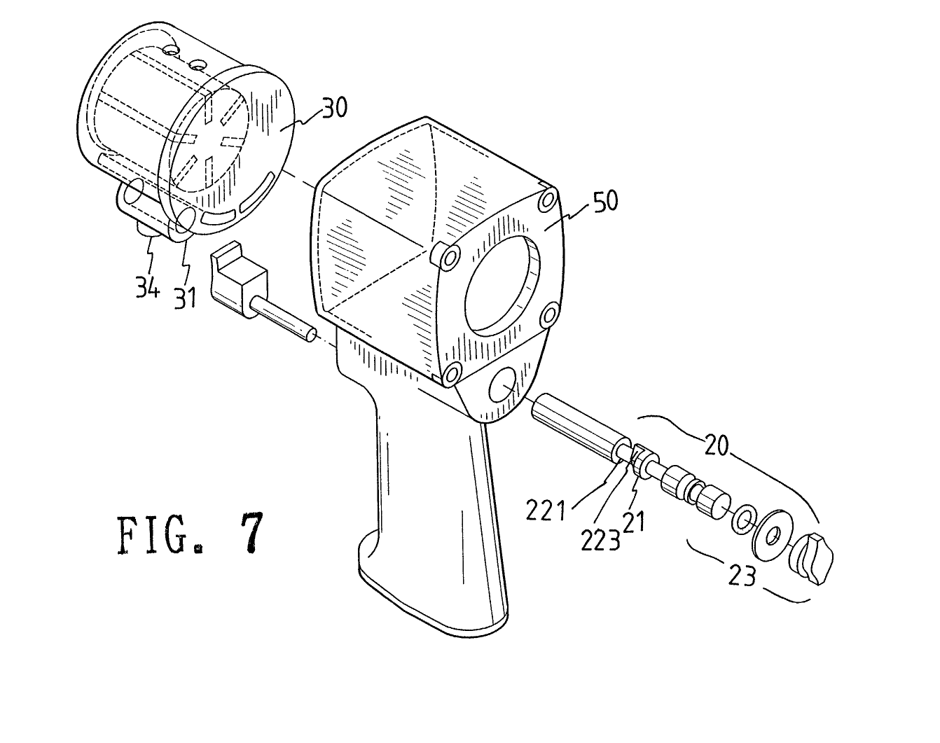

FIG. 7 shows that a semi-circular block 223 extends radially outward from a periphery one of the recesses 221, 222. As shown in FIG. 8, the block 223 is shifted to partially block either one of the first passage 32 or the second passage 33 to micro-adjust the amount of air entering the casing 30.

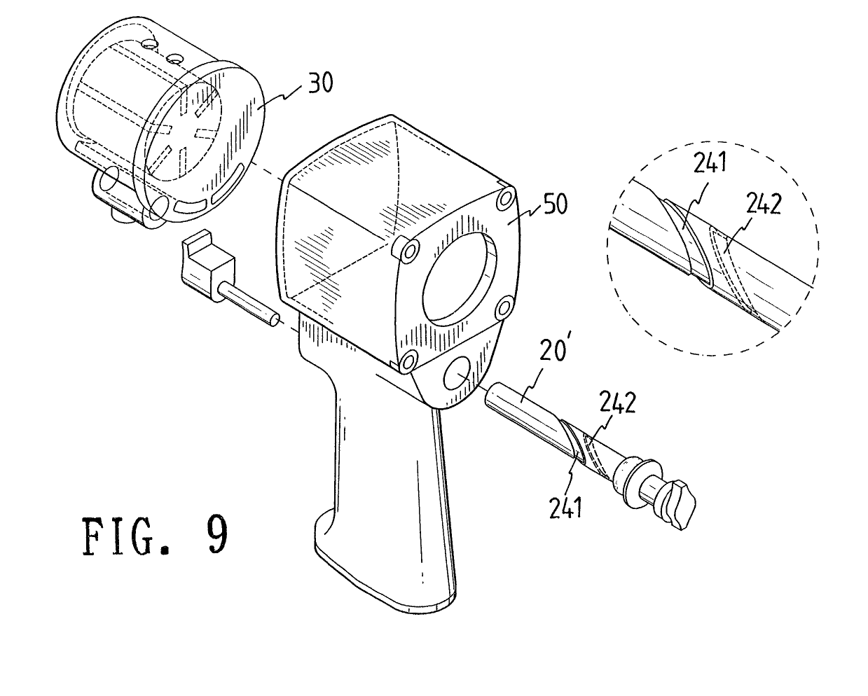

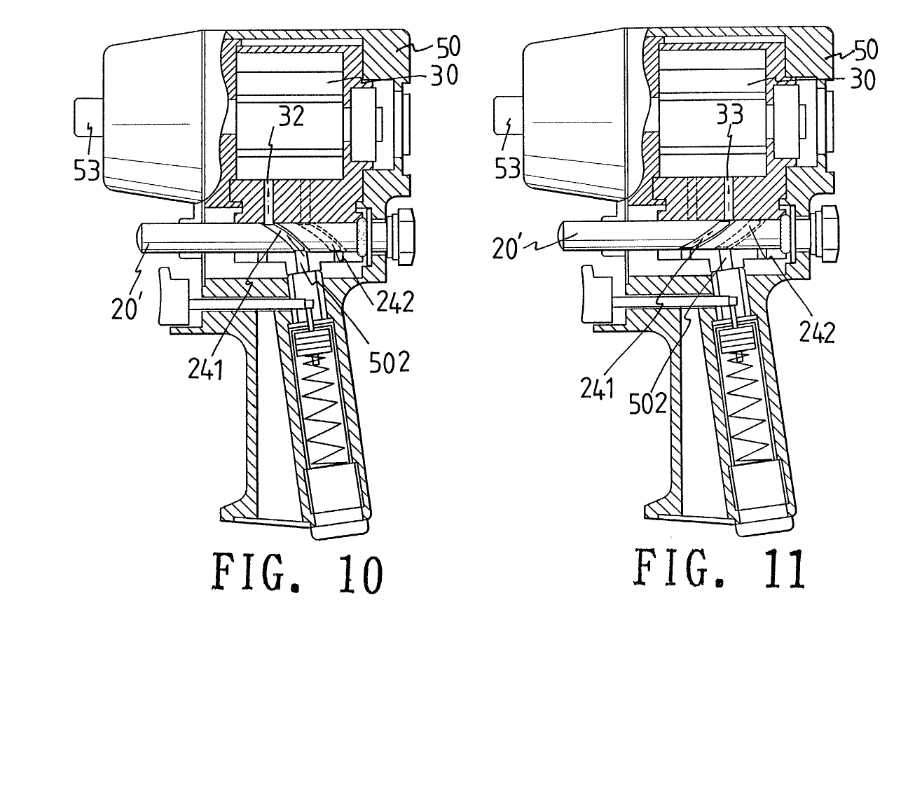

FIG. 9 shows that the two recesses each are defined in a form of a spiral groove 241/242 and the control bar 20′ is operated by rotating it to let the positions of the two grooves 214, 242 be shifted to communicate with the first passage 32 or the second passage 33 respectively as shown in FIGS. 10 and 11.

While we have shown and described various embodiments in accordance with the present invention, it should be clear to those skilled in the art that further embodiments may be made without departing from the scope of the present invention.

What is claimed is:

1. A pneumatic tool comprising:
a barrel portion and a handle in which a passage is defined and adapted to be connected to an air compressor, a casing securely received in said barrel portion and a rotator rotatably received in said casing, a chuck device connected to said rotator, a tube connected to said casing, a first passage and a second passage respectively connected in communication between said casing and said tube, an inlet defined radially through said tube and communicating with said passage in said handle, and
a control bar received in said tube and two recesses respectively defined in an outer periphery of said control bar, said two recesses movably communicating with said first passage and said second passage in said tube.

2. The tool as claimed in claim 1, wherein said control bar has a separation flange and said two recesses are separated by said separation flange, said control bar movable in a longitudinal direction of said tube and positions of said two recesses are moved relative to said tube when pulling said control bar.

3. The tool as claimed in claim 2 further comprising a block extending radially outward from a periphery one of said recesses.

4. The tool as claimed in claim 1, wherein said two recesses each are defined in a form of a spiral groove.
